(19) United States
(12) Patent Application Publication
(10) Pub. No.: US 2005/0144621 A1
(43) Pub. Date: Jun. 30, 2005

(54) CSTA services library

(76) Inventor: Trevor A. Millbery, Winchester (GB)

Correspondence Address: BLAKELY, SOKOLOFF, TAYLOR & ZAFMAN LLP;Seventh Floor, 12400 Wilshire Boulevard, Los Angeles, CA, 90025, US

(21) Appl. No.: 10/745,722

(22) Filed: Dec. 23, 2003

(51) Int. Cl. G06F 3/00; G06F 9/44; G06F 9/46; G06F 13/00

(52) U.S. Cl. 719/310

(57) ABSTRACT

In one embodiment, a method is provided. The method of this embodiment provides receiving one or more CSTA3 (Computer Supported Telecommunications Applications Phase III) service requests from a control application; decoding the one or more CSTA3 service requests; generating one or more switch service requests corresponding to the one or more CSTA3 service requests; and reporting the one or more switch service requests to a switch application.

### FIELD

Embodiments of this invention relate to a CSTA (Computer Supported Telecommunications Applications) services library.

### BACKGROUND

ECMA (European Computer Manufacturers Association) is an industry association that provides standards for information and communications technologies and consumer electronics. ECMA provides a protocol for computer supported telecommunications applications (CSTA). There are various phases of the CSTA protocol. For example, the latest protocol, as of the filing date of this application, is the CSTA3 protocol, which is described in “Protocol for Computer Supported Telecommunications Applications (CSTA) Phase III”, Standard ECMA-285, 2^{nd} Edition, June 2000 (hereinafter “Standard ECMA-285”). Services and events in the CSTA3 protocol are described in “Services for Computer Supported Telecommunications Applications (CSTA) Phase III”, Standard ECMA-269, 5^{th} Edition, December 2002 (hereinafter “Standard ECMA-269”). Definitions used in the CSTA3 protocol are described in “Glossary of Definitions and Terminology for Computer Supported Telecommunications Applications (CSTA) Phase III”, ECMA Technical Report TR/72, 3^{rd} Edition, June 2000 (hereinafter “TR/72”). Other phases include CSTA1 (CSTA Phase I), which is described in “Protocol for Computer Supported Telecommunications Applications (CSTA) Phase I”, Standard ECMA-180, June 1992, and CSTA2 (CSTA Phase II), which is described in “Protocol for Computer Supported Telecommunications Applications (CSTA) Phase II”, Standard ECMA-218, December 1994.

The CSTA protocol may be used to provide computer telephony/telecommunications integration (“CTI”) between a telecommunications-based system, such as a switching system, and a computer-based system, such as a call center. A telecommunications-based system may provide one or more services, such as the receipt, transmission, or emission of signs, signals, writing, images, sounds, or intelligence of any nature by wire, radio, optical, or other electromagnetic systems. A computer-based system may control the operation of a telecommunications-based system, and/or use the one or more services of a telecommunications-based system.

While a computer-based system may be CSTA-compliant by operating in accordance with CSTA standards and definitions, for example, a telecommunications-based system may not be CSTA-compliant. Consequently, CSTA messages from a computer-based system may need to be translated by a telecommunications-based system into language that the telecommunications-based system can use, and vice versa. However, development or modification of such a telecommunications-based system may be very tedious and complex.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a network.

FIG. 2 illustrates a system.

FIG. 3 illustrates a system embodiment that may be implemented in system of FIG. 2.

FIG. 4 illustrates a CSTA services library according to one embodiment of the invention.

FIG. 5 is a flowchart illustrating a method according to one embodiment.

FIG. 6 is a flowchart illustrating a method according to another embodiment.

### DETAILED DESCRIPTION

Embodiments of the present invention include various operations, which will be described below. The operations associated with embodiments of the present invention may be performed by hardware components or may be embodied in machine-executable instructions, which when executed may result in a general-purpose or special-purpose processor or circuitry programmed with the machine-executable instructions performing the operations. Alternatively, and/or additionally, some or all of the operations may be performed by a combination of hardware and software.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

Introduction

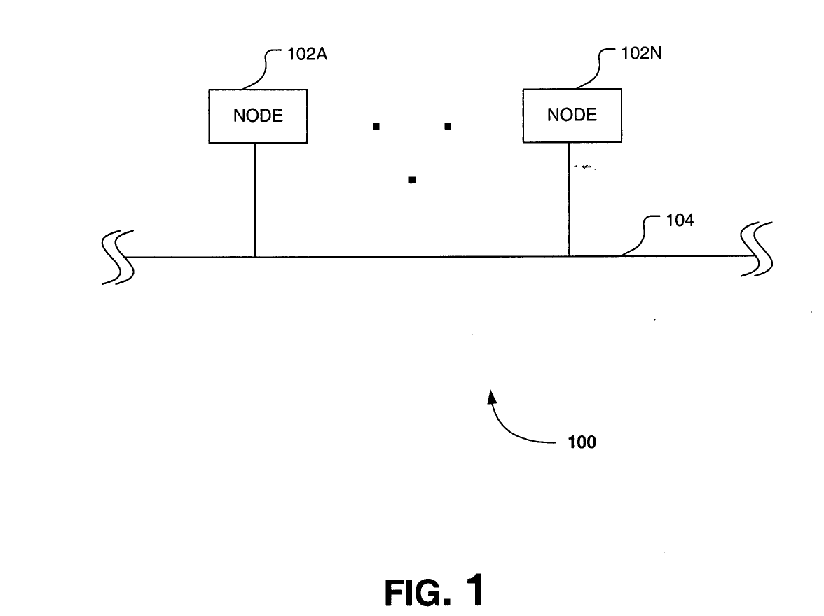

FIG. 1 illustrates one example of a network 100 in which embodiments of the invention may be carried out. Network 100 may comprise, for example, one or more computer nodes 102A . . . 102N (hereinafter “nodes”) communicatively coupled together via a communication medium 104. As used herein, components that are “communicatively coupled” means that the components may be capable of communicating with each other via wirelined (e.g., copper wires), or wireless (e.g., radio frequency) means. Nodes 102A . . . 102N may transmit and receive sets of one or more signals via medium 104 that may encode one or more packets. As used herein, a “packet” means a sequence of one or more symbols and/or values that may be encoded by one or more signals transmitted from at least one sender to at least one receiver.

As used herein, a “communication medium” means a physical entity through which electromagnetic radiation may be transmitted and/or received. Medium 104 may comprise, for example, one or more optical and/or electrical cables, although many alternatives are possible. For example, medium 104 may comprise, for example, air and/or vacuum, through which nodes 102A . . . 102N may wirelessly transmit and/or receive sets of one or more signals.

In network 100, one or more of the nodes 102A . . . 102N may comprise one or more intermediate stations, such as, for example, one or more hubs, switches, and/or routers; additionally or alternatively, one or more of the nodes 102A . . . 102N may comprise one or more end stations. Also additionally or alternatively, network 100 may comprise one or more not shown intermediate stations, and medium 104 may communicatively couple together at least some of the nodes 102A . . . 102N and one or more of these intermediate stations. Of course, many alternatives are possible.

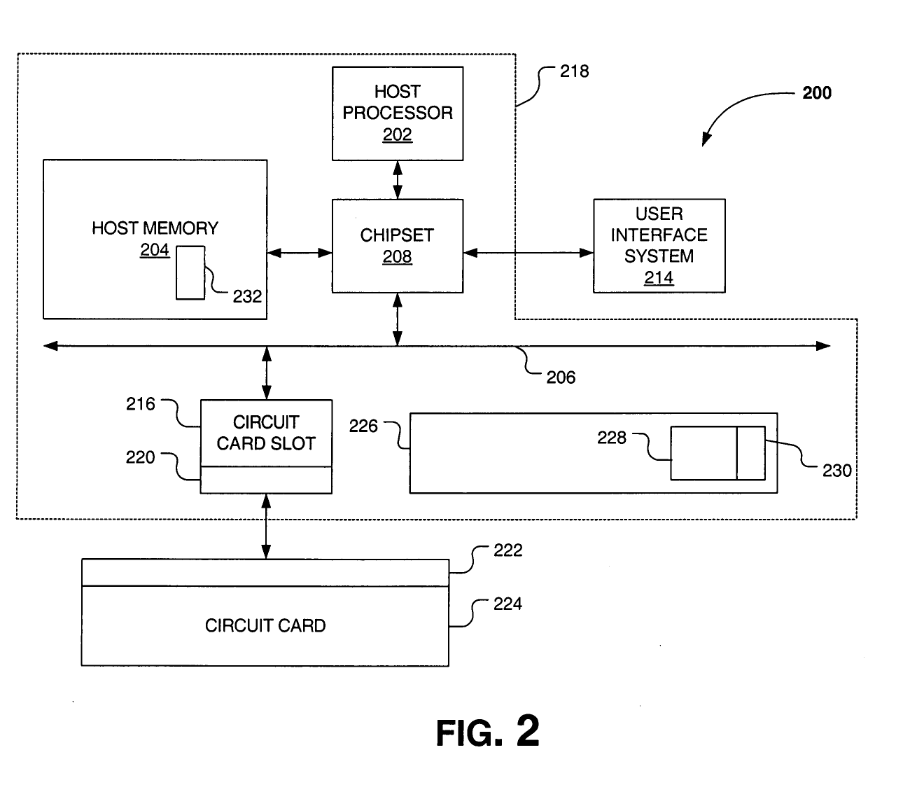

FIG. 2 illustrates system 200, which may comprise a node 102A . . . 102N on network 100. System 200 may comprise host processor 202, host memory 204, bus 206, and chipset 208. (System 200 may comprise more than one host processor 202, host memory 204, bus 206, and chipset 208; however, for simplicity of illustration, only one of each is illustrated and described herein.) Host processor 202 may comprise, for example, an Intel® Pentium® microprocessor that is commercially available from the Assignee of the subject application. Of course, alternatively, host processor 202 may comprise another type of microprocessor, such as, for example, a microprocessor that is manufactured and/or commercially available from a source other than the Assignee of the subject application, without departing from this embodiment.

Host processor 202 may be communicatively coupled to chipset 208. Chipset 208 may comprise a host bridge/hub system that may couple host processor 202, host memory 204, and a user interface system 214 to each other and to bus 206. Chipset 208 may also include an I/O bridge/hub system (not shown) that may couple the host bridge/bus system 208 to bus 206. Chipset 208 may comprise one or more integrated circuit chips, such as those selected from integrated circuit chipsets commercially available from the Assignee of the subject application (e.g., graphics memory and I/O controller hub chipsets), although other one or more integrated circuit chips may also, or alternatively, be used. User interface system 214 may comprise, e.g., a keyboard, pointing device, and display system that may permit a human user to input commands to, and monitor the operation of, system 200.

Bus 206 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Alternatively, bus 206 instead may comprise a bus that complies with the PCI-X Specification Rev. 1.0a, Jul. 24, 2000, available from the aforesaid PCI Special Interest Group, Portland, Oreg., U.S.A. (hereinafter referred to as a “PCI-X bus”). Also, alternatively, bus 206 may comprise other types and configurations of bus systems.

Host processor 202, host memory 204, bus 206, chipset 208, and circuit card slot 216 may be comprised in a single circuit board, such as, for example, a system motherboard 218. Circuit card slot 216 may comprise a PCI expansion slot that comprises a PCI bus connector 220. PCI bus connector 220 may be electrically and mechanically mated with a PCI bus connector 222 that is comprised in circuit card 224. Circuit card slot 216 and circuit card 224 may be constructed to permit circuit card 224 to be inserted into circuit card slot 216. When circuit card 224 is inserted into circuit card slot 216, PCI bus connectors 220, 222 may become electrically and mechanically coupled to each other. When PCI bus connectors 220, 222 are so coupled to each other, circuitry (generally shown as circuitry 226 on motherboard 218) in circuit card 224 may become electrically coupled to bus 206. System 200 may include a plurality of cards, identical in construction and/or operation to circuit card 224, coupled to bus 206 via a plurality of circuit card slots identical in construction and/or operation to circuit card slot 216.

System may comprise circuitry 226. Circuitry 226 may comprise one or more circuits to perform one or more operations described herein as being performed by circuitry 226. Circuitry 226 may be hardwired to perform the one or more operations, and/or may execute machine-executable instructions to perform these operations. For example, circuitry 226 may comprise memory 228 that may store machine-executable instructions 230 that may be executed by circuitry 226 to perform these operations. Instead of being comprised in motherboard 218, some or all of circuitry 226 may be comprised in host processor 202, circuit card 224, and/or other structures, systems, and/or devices that may be, for example, comprised in motherboard 218, and/or communicatively coupled to bus 206, and may exchange data and/or commands with one or more other components in system 200. For example, chipset 208 may comprise one or more integrated circuits that may comprise some or all of circuitry 226. Circuitry 226 may comprise, for example, one or more digital circuits, one or more analog circuits, one or more state machines, programmable circuitry, and/or one or more ASIC's (Application-Specific Integrated Circuits).

System 200 may comprise one or more memories to store machine-executable instructions 230, 232 capable of being executed, and/or data capable of being accessed, operated upon, and/or manipulated by circuitry, such as circuitry 226. For example, these one or more memories may include host memory 204, and/or memory 228. One or more memories 204 and/or 228 may, for example, comprise read only, mass storage, random access computer-readable memory, and/or one or more other types of machine-readable memory. The execution of program instructions 230, 232 and/or the accessing, operation upon, and/or manipulation of this data by circuitry 226 may result in, for example, circuitry 226 carrying out some or all of the operations described herein.

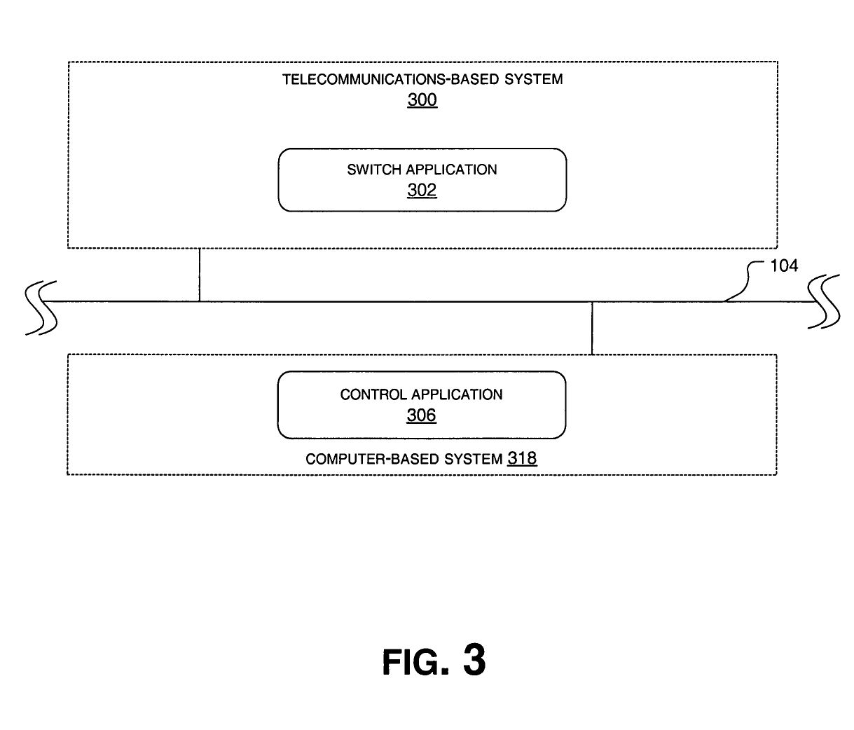

FIG. 3 illustrates a network embodiment of the invention, the network having nodes 300, 318 that are communicatively coupled via medium 104. Telecommunications-based system 300 node may include switch application 302, and computer-based system 318 node may include control application 306. Telecommunications-based system 300 and computer-based system 318 may each be comprised in a system, such as system 200.

Telecommunications-based system 300 may comprise, for example, a switching system, or a switch simulator. A “switching system”, as used herein, refers to a system that may include one or more switching centers to control and/or route calls. A switching system may comprise, for example, a traditional telephone system, an open switching system, a public network switching system, or an H.323 (an ITU—International Telecommunications Union—standard for packet-based multimedia communications systems) packet voice services system. A public network switching system may comprise, for example, a PBX (private branch exchange). A “PBX” refers to a mechanism to provide a private telecommunications network that allows telephone communications between internal stations, as well as between internal stations and an external telephone network. A PBX may comprise, for example, a Siemens® Hicom™ 300 switch, which is commercially available through Siemens® AG.

A “switch simulator” refers to software that may simulate a telephone environment for testing control applications and/or applications without a standard telephone system, for example. A switch simulator may comprise, for example, Intel® CSTA* Switch Simulator (where “*” may refer to a particular CSTA phase).

Computer-based system 318 may control the one or more services of telecommunications-based system 300, and/or receive one or more services of telecommunications-based system 300. For example, computer-based system 318 may direct calls received on telecommunications-based system 300 to voice mail, collect data (e.g., telephony tones) related to a call received on telecommunications-based system 300, and/or send messages to one or more devices in telecommunications-based system 300. Computer-based system 318 may comprise, for example, a call center, such as a telephony handset, or an emergency service call recorder and tracker.

Telecommunications-based system 300 and computer-based system 318 may communicate via switch application 302 on telecommunications-based system 300, and via control application 306 on computer-based system 318. Control application 306 may be CSTA-compliant, and may send to and/or receive from switch application 302 one or more CSTA messages, where switch application 302 may not be CSTA-compliant. As used herein, a “CSTA message” refers to a communication that conforms to at least one CSTA protocol, including CSTA1, CSTA2, and CSTA3. CSTA3 may include improvements over CSTA1 and/or CSTA2, such as:

New categories of services and events such as capabilities exchange, charging, media attach services, and call data recording (CDR).
Additional services and events for call and device control.
Enhancement to existing services and events.
Organization of services and events to reflect a grouping based on function (e.g., call control, device control).

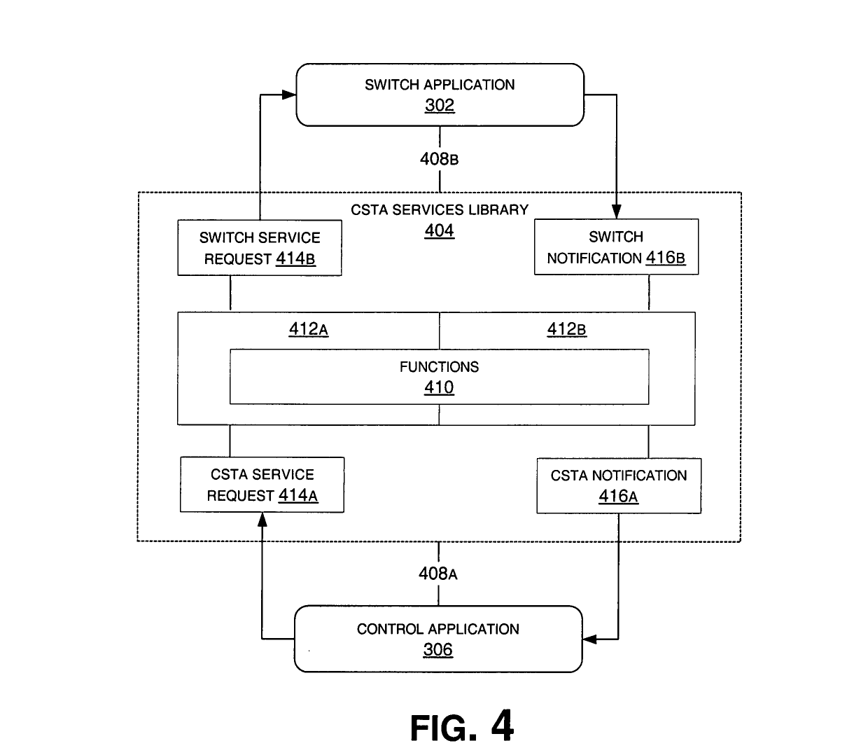

As illustrated in FIG. 4, switch application 302 and control application 306 may send and receive switch messages and CSTA messages, respectively, via CSTA services library 404. CSTA services library may enable telecommunications-based system 300 to access one or more CSTA services. CSTA services may be described in Standard ECMA-269, supra. Examples of CSTA services include providing information about devices participating in a call, providing information on the status of calls at a specified device, placing an existing call on hold and retrieving a previously held call or alerting call at the same device, answering a call, transferring a call, or playing or deleting voice call, for example. Of course, these examples are not exhaustive.

In one embodiment, a CSTA message may comprise a CSTA service request 414A or a CSTA notification 416A. CSTA message may be translated to a switch message using set of functions 410 that may be accessible via one or more interfaces 412A, 412B. Set of functions 410 may be called to construct, transmit, receive, decode, encode, and/or parse one or more CSTA messages and one or more switch messages. A switch message may comprise a switch service request 414B or a switch notification 416B.

CSTA services library 404 may reside on a first system, such as system 200, with a host application to communicate with a remote application on a second system. “Host application” refers to an application on the same system as CSTA services library, and with which a CSTA services library may be integrated. A host application with which a CSTA services library is integrated is an application that may initiate and shutdown a CSTA services library, for example. “Remote application” refers to an application on a different system than CSTA services library. A CSTA services library 404 may receive CSTA messages from, and transmit CSTA messages to, one or more remote applications.

In one embodiment, CSTA services library 404 may be integrated with switch application 302, wherein CSTA services library 404 and switch application 302 may reside on telecommunications-based system 300. In this embodiment, remote application may include control application 306. In another embodiment, host application may be integrated with another switch application (not illustrated), wherein CSTA services library 404 and the other switch application may reside on another telecommunications-based system (not shown), similar in construction and/or in operation to telecommunications-based system 300. In this embodiment, the other telecommunications-based system (not shown) may transmit and receive switch messages from telecommunications-based system 300. Also, remote application may include control application 306 as well as switch application 302. In yet another embodiment, host application may be integrated with control application 306, wherein CSTA services library 404 and control application 306 may reside on computer-based system 318. In this embodiment, control application 306 may be, for example, a protocol converter application. In this embodiment, remote application may include switch application 302.

CSTA services library 404 may communicate with remote application via a connection on a medium, such as medium 104. In one embodiment, host application may comprise switch application 302, and CSTA services library 404 may communicate with control application 306 via connection 408A. In another embodiment, host application may comprise control application 306, and CSTA services library 404 may communicate with switch application 302 via connection 408B. Connection 408A, 408B may be on an Ethernet LAN (local area network) using a protocol, such as TCP/IP (Transmission Control Protocol/Internet Protocol), for example. However, there are other possibilities, such as an ISDN (Integrated Services Digital Network) telephony connection, X25 network, or an RS-232 serial link, which may use other protocols, such as UDP (User Datagram Protocol), and underlying transport protocols that may be proprietary to a particular manufacturer.

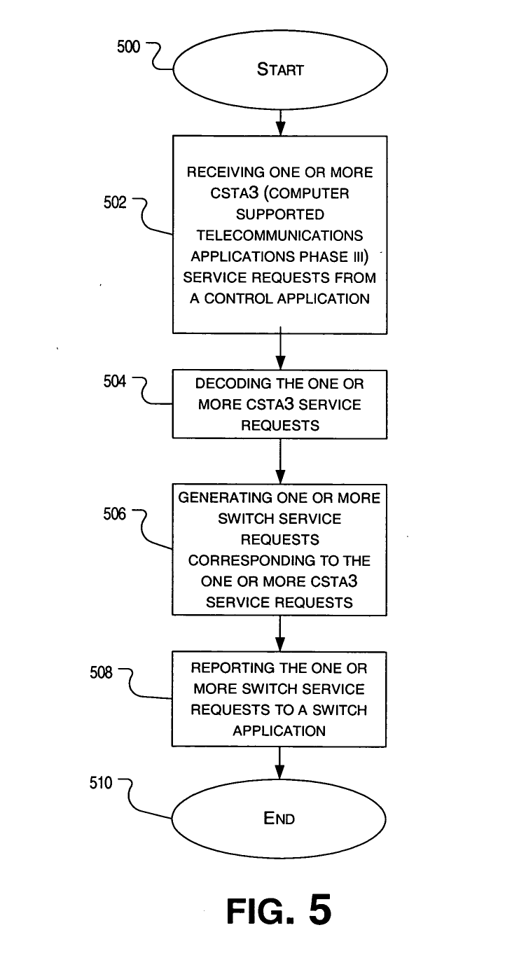

FIG. 5 is a flowchart illustrating a method according to one embodiment. The method begins at block 500 and continues to block 502 where CSTA services library 404 may receive one or more CSTA3 service requests 414A from control application 306. CSTA services library 404 may receive one or more other CSTA3 service requests from one or more other control applications. At block 504, CSTA services library 404 may decode the one or more CSTA3 service requests 414A. At block 506, CSTA services library 404 may generate one or more switch service requests 414B corresponding to the one or more CSTA3 service requests 414A. At block 508, CSTA services library 404 may report the one or more switch service requests 414B to switch application 302. The method ends at block 510.

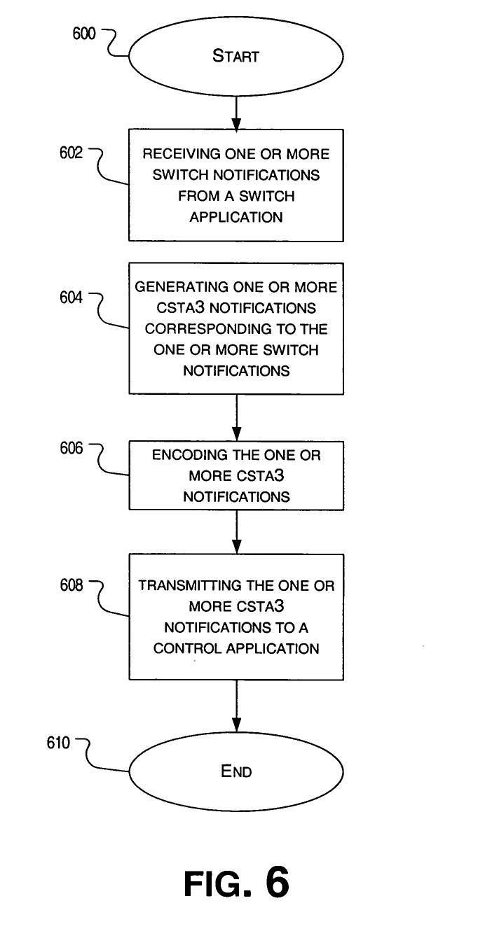

FIG. 6 is a flowchart illustrating a method according to another embodiment. The method begins at block 600, and continues to block 602 where CSTA services library 404 may receive one or more switch notifications 416B from switch application 302. At block 604, CSTA services library 404 may generate one or more CSTA3 notifications 416A corresponding to the one or more switch notifications 416B. At block 606, CSTA services library 404 may encode the one or more CSTA3 notifications 416A, and at block 608, CSTA services library 404 may report the one or more CSTA3 notifications 416A to control application 306. The method ends at block 610.

Further to the methods of FIG. 5 and FIG. 6, CSTA services library 404 may be initialized and shutdown by host application, report connection 408A, 408B or lack of connection 408A, 408B (i.e., disconnection) to host application, and close connection 408A, 408B with host application. For example, host application may comprise switch application 302, and control application 306 may send a CSTA message to switch application 302. Switch application 302 may initialize CSTA services library 404, and CSTA services library 404 may report connection 408A, 408B to switch application 302. Control application 306 and switch application 302 may begin communicating via CSTA services library 404. Likewise, host application may shutdown CSTA services library 404, and CSTA services library 404 may close connection 408A, 408B with host application, and report lack of connection 408A, 408B to host application. CSTA services library 404 may additionally report general errors to host application. General errors may comprise, for example, transmission errors and reception errors.

CSTA Service Requests and Notifications

CSTA service request 414A may comprise a request sent to switch application 302 to use one or more CSTA services to enable control application 306 to control and observe CSTA objects within telecommunications-based system 300, for example. A “CSTA object” refers to a conceptual entity that may be recognized by a CSTA-compliant system, where the conceptual entity may comprise, for example, a call, a connection, or a device. A CSTA notification 416A may comprise a response or an event sent to control application 306.

A response (referred to as an “acknowledgment” in CSTA) may be a message sent from switch application 302 to control application 306, informing control application 306 whether a previously-sent CSTA service request 414A was accepted or rejected. In CSTA3, for example, a response may indicate that parameters to a function call were accepted, that the requested service request was completed and that the parameters to the function were accepted, or that the service request failed.

An event may be a message provided by switch application 302 to control application 306 to indicate a change of state of a CSTA object. An event may be asynchronous. Furthermore, events may be generated in response to, or independently of, a CSTA message from control application 306. An event may comprise, for example, indication that a message is being played, recorded, or reviewed, indication that a device has been taken out of service, or indication that an existing call has been put on hold. Of course, these examples are illustrative and are not exhaustive. Other CSTA responses and/or events are described in Standard ECMA-269, supra.

Switch Service Requests and Notifications

CSTA service request 414A may be used to generate one or more switch service requests 414B. CSTA services library 404 may use one or more CSTA request functions in the set of functions 410 to generate one or more switch service requests 414B from one or more CSTA service requests 414A. One or more CSTA request functions of set of functions 410 may return one or more switch service requests 414B. One or more switch service requests 414B may conform to requirements and features of switch application 302, and may be reported to switch application 302. In one embodiment, one or more CSTA request functions of the set of functions 410 may be pre-determined and made available by switch application 302, wherein a given CSTA service request 414A may be mapped to a pre-specified CSTA request function that generates a switch service request 414B corresponding to the CSTA service request 414A.

Switch application 302 may generate one or more switch notifications 416B. One or more switch notifications 416B may be generated by switch application 302 independently of one or more CSTA service requests 414A from control application 306. Alternatively, one or more switch notifications 416B may be in response to CSTA service requests 414A, and based on nature of one or more switch service requests 416B. For example, if a switch service request 414B is directed to establishing a call between two devices, then an appropriate switch notification 416B may comprise a switch response indicating, for example, that the request failed, or a switch event indicating that a device in a call has disconnected or dropped out from a call. In some cases, one or more switch responses and one or more switch events may be returned. Other possibilities, of course, may exist.

One or more switch notifications 416B may be sent from switch application 302 to CSTA services library 404. CSTA services library 404 may generate one or more CSTA notifications 416A based on one or more switch notifications 416B. In this respect, CSTA services library 404 may use one or more CSTA response and/or CSTA event functions in set of functions 410 to generate one or more CSTA notifications 416A based on the one or more switch notifications 416B. One or more CSTA notifications 416A may conform to CSTA protocol, which may be transmitted to control application 306. In one embodiment, one or more CSTA response and/or CSTA event functions of the set of functions 410 may be pre-determined and published by CSTA services library 404, wherein a given switch notification 416B may be mapped to a pre-specified CSTA response or CSTA event function that generates a CSTA notification 416A corresponding to the switch notification 416B.

Decoding and Encoding One or More CSTA Service Requests

One or more CSTA service requests 414A may be decoded, and parsed into request information and request data. Request information may comprise, for example, source (e.g., control application 306) and destination (e.g., switch application 302) addresses. Request data may comprise, for example, one or more parameters that may be used by CSTA services library 404 to return one or more CSTA notifications 416A. CSTA services library 404 may use request data from CSTA service request 414A as one or more parameters to the one or more switch service requests 414B.

One or more switch notifications 416B may be constructed into one or more CSTA notifications, and then encoded. “Construction” means to organize information into an appropriate format to transmit the information. For example, CSTA notifications may be formatted into ATM (Asynchronous Transfer Mode) packets, or into TCP/IP packets, for example. Encoding may be accomplished using ASN.1 (Abstract Syntax Notation One), for example. “ASN.1” refers to an ISO (International Organization for Standardization)/ITU (International Telecommunications Union) standard based on the OSI (Open Standards Interconnection) model for defining a networking framework that may implement protocols in seven layers (i.e., Application Layer, Presentation Layer, Session Layer, Transport Layer, Network layer, Data Link Layer, and Physical Layer). The ASN.1 standard is described in “Information Technology—Abstract Syntax Notation One (ASN.1) & ASN.1 encoding rules”, X.680-X.693, published July, 2002, available from the ITU.

ASN.1 may ensure that the data received is the same as the data transmitted by providing a common syntax for specifying Application Layer (i.e., program-to-program communications) protocols. ASN.1 encoding specifies a means of encoding whereby data may be dynamically encoded such that the data occupies as small a space as possible. This is in contrast to static encoding methods whereby fields may be given fixed sizes, and may be padded with default values even though the actual data may be smaller than the field size. ASN.1 based encoding protocol for CSTA Phase III is defined in Standard ECMA-285.

As another example, encoding may be accomplished using XML (Extensible Markup Language). The XML specification is described in “Extensible Markup Language (XML) 1.0 (Second Edition) W3C Recommendation”, by Tim Bray, Jean Paoli, C. M. Sperberg-McQueen, and Eve Maler, published on Oct. 6, 2000. XML is a text formatting language using tags. Tags are commands that may be inserted into a document that specify how the document, or one or more portions thereof, should be formatted. XML based encoding protocol for CSTA Phase III is defined in “XML Protocol for Computer Supported Telecommunications Applications (CSTA) Phase III”, Standard ECMA-323, 2^{nd} Edition, December 2002.

Interfaces

In one embodiment, CSTA services library 404 may comprise a request interface, such as interface 412A. Request interface 412A may comprise one or more functions in set of functions 410 that may be called to report and/or generate messages to switch application 302 and/or host application.

Request interface 412A may comprise CSTA request functions. These functions may enable CSTA services library 404 to receive one or more CSTA service requests 414A from control application 306, decode one or more CSTA service requests 414A, generate one or more switch service requests 414B corresponding to the one or more decoded CSTA service requests 414A, and report one or more switch service requests 414B to switch application 302.

Request interface 412A may also comprise management status functions. These functions may enable CSTA services library 404 to report connection 408A, 408B, lack of connection 408A, 408B, and general errors to host application.

Request interface 412A may comprise a table of addresses to CSTA request functions and management status functions, for example. Addresses to CSTA request functions may be provided by switch application 302 and addresses to management status functions may be provided by host application, for example. In one embodiment, addresses may be provided by switch application when switch application 302 initializes CSTA services library 404.

CSTA services library 404 may additionally comprise a notification interface, such as interface 412B. Notification interface 412B may comprise one or more functions in set of functions 410 that may be called to report and/or generate messages to control application 306 and/or host application.

Notification interface 412B may comprise CSTA response functions. These functions may enable CSTA services library 404 to receive one or more switch responses (e.g., 416B) from switch application 402, generate one or more CSTA responses (e.g., 416A) corresponding to the one or more switch responses (e.g., 416B), encode the one or more CSTA responses (e.g., 416A), and transmit the one or more CSTA responses (e.g., 416A) to control application 306.

Notification interface 412B may also comprise CSTA event functions. These functions may enable CSTA services library 404 to receive one or more switch events (e.g., 416B) from switch application 302, generate one or more CSTA events (e.g., 416A) corresponding to the one or more switch events (e.g., 416B), encode the one or more CSTA events (e.g., 416A), and transmit the one or more CSTA events (e.g., 416A) to control application 306.

Notification interface 412B may further comprise management control functions. These functions may enable host application to initialize CSTA services library 404, closedown CSTA services library 404, and instruct CSTA services library 404 to close a connection, such as connection 408A, 408B.

One or more CSTA response functions, CSTA event functions, and management control functions may be published by CSTA services library 404 to switch application 302 and/or host application.

### Conclusion

Therefore, in one embodiment, a method may comprise receiving one or more CSTA3 (Computer Supported Telecommunications Applications Phase III) service requests from a control application; decoding the one or more CSTA3 service requests; generating one or more switch service requests corresponding to the one or more CSTA3 service requests; and reporting the one or more switch service requests to a switch application.

Embodiments of the invention may encapsulate CSTA message processing, insulating switch applications from CSTA message processing. As a result, complexities that may be involved in developing switch applications may be reduced since switch applications need not be concerned with the construction, transmission, reception, decoding, encoding, and parsing of CSTA messages. Instead, switch applications may interface with and use CSTA services library for CSTA message processing, and may focus on responding appropriately to the CSTA messages.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

1. A method comprising:
receiving one or more CSTA3 (Computer Supported Telecommunications Applications Phase III) service requests from a control application;
decoding the one or more CSTA3 service requests;
generating one or more switch service requests corresponding to the one or more CSTA3 service requests; and
reporting the one or more switch service requests to a switch application.

2. The method of claim 1, additionally comprising receiving one or more request functions from the switch application.

3. The method of claim 1, additionally comprising publishing one or more response functions to the switch application.

4. The method of claim 1, additionally comprising publishing one or more event functions to the switch application.

5. The method of claim 1, wherein the one or more CSTA3 service requests are encoded using ASN.1 (Abstract Syntax Notation One).

6. The method of claim 1, wherein the one or more CSTA3 service requests are encoded using XML (Extensible Markup Language).

7. The method of claim 1, wherein the method additionally comprises:
receiving one or more other CSTA3 requests from at least one other control application;
decoding the one or more other CSTA3 service requests;
generating one or more other switch service requests corresponding to the one or more other CSTA3 service requests; and
reporting the one or more other switch service requests to a switch application.

8. The method of claim 1, wherein the method additionally comprises reporting the one or more switch service requests to at least one other switch application.

9. The method of claim 1, comprising:
receiving one or more switch notifications from the switch application;
generating one or more CSTA3 notifications corresponding to the one or more switch notifications;
encoding the one or more CSTA3 notifications; and
reporting the one or more CSTA3 notifications to the control application.

10. The method of claim 1, wherein the one or more switch notifications comprise one or more responses to the one or more switch service requests.

11. The method of claim 1, wherein the one or more switch notifications comprise one or more asynchronous events.

12. A method comprising:
receiving one or more switch notifications from a switch application;
generating one or more CSTA3 notifications corresponding to the one or more switch notifications;
encoding the one or more CSTA3 notifications; and
reporting the one or more CSTA3 notifications to a control application.

13. The method of claim 12, additionally comprising publishing one or more response functions to the switch application.

14. The method of claim 12, additionally comprising publishing one or more event functions to the switch application.

15. The method of claim 12, wherein the one or more CSTA3 notifications are encoded using ASN.1 (Abstract Syntax Notation One).

16. The method of claim 12, wherein the one or more CSTA3 notifications are encoded using XML (Extensible Markup Language).

17. An apparatus comprising:
circuitry capable of:
receiving one or more CSTA3 (Computer Supported Telecommunications Applications Phase III) service requests from a control application;
decoding the one or more CSTA3 service requests;
generating one or more switch service requests corresponding to the one or more CSTA3 service requests; and
reporting the one or more switch service requests to a switch application.

18. The apparatus of claim 17, wherein the one or more CSTA3 service requests are encoded using ASN.1 (Abstract Syntax Notation One).

19. The apparatus of claim 17, wherein the one or more CSTA3 service requests are encoded using XML (Extensible Markup Language).

20. The apparatus of claim 17, wherein the method additionally comprises:
receiving one or more other CSTA3 requests from at least one other control application;
decoding the one or more other CSTA3 service requests;
generating one or more other switch service requests corresponding to the one or more other CSTA3 service requests; and
reporting the one or more other switch service requests to a switch application.

21. A system comprising:
a switching system; and
circuitry capable of:
receiving one or more CSTA3 (Computer Supported Telecommunications Applications Phase ll) service requests from a control application;
decoding the one or more CSTA3 service requests;
generating one or more switch service requests corresponding to the one or more CSTA3 service requests; and
reporting the one or more switch service requests to the switching system.

22. The system of claim 21, wherein said switching system comprises a PBX (private branch exchange).

23. The system of claim 21, said circuitry additionally capable of:
receiving one or more switch notifications from the switching system;
generating one or more CSTA3 notifications corresponding to the one or more switch notifications;
encoding the one or more CSTA3 notifications; and
reporting the one or more CSTA3 notifications to the control application.

24. The system of claim 23, wherein the one or more CSTA3 service requests and one or more CSTA3 notifications are encoded using XML (Extensible Markup Language).

25. A system comprising:
a call center; and
circuitry capable of:
receiving one or more CSTA3 (Computer Supported Telecommunications Applications Phase 111) service requests from the call center;
decoding the one or more CSTA3 service requests;
generating one or more switch service requests corresponding to the one or more CSTA3 service requests; and
reporting the one or more switch service requests to a switch application.

26. The system of claim 25, said circuitry additionally capable of:
receiving one or more switch notifications from the switching system;
generating one or more CSTA3 notifications corresponding to the one or more switch notifications;
encoding the one or more CSTA3 notifications; and
reporting the one or more CSTA3 notifications to the control application.

27. The system of claim 25, wherein the one or more CSTA3 service requests and one or more CSTA3 notifications are encoded using XML (Extensible Markup Language).

28. A machine-readable medium having stored thereon instructions, the instructions when executed by a machine, result in the following:
receiving one or more CSTA3 (Computer Supported Telecommunications Applications Phase 111) service requests from a control application;
decoding the one or more CSTA3 service requests;
generating one or more switch service requests corresponding to the one or more CSTA3 service requests; and
reporting the one or more switch service requests to a switch application.

29. The machine-readable medium of claim 28, wherein the one or more CSTA3 service requests are encoded using XML (Extensible Markup Language).

30. The machine-readable medium of claim 28, wherein the instructions when executed by a machine, additionally result in the following:
receiving one or more other CSTA3 requests from at least one other control application;
decoding the one or more other CSTA3 service requests;
generating one or more other switch service requests corresponding to the one or more other CSTA3 service requests; and
reporting the one or more other switch service requests to a switch application.
